(19) United States
(12) Patent Application Publication
(10) Pub. No.: US 2017/0035267 A1
(43) Pub. Date: Feb. 9, 2017

(54) SHOE CLEANING SYSTEM

(71) Applicant: Shahriar Bassiri, Tehran (IR)

(72) Inventor: Shahriar Bassiri, Tehran (IR)

(21) Appl. No.: 15/331,928

(22) Filed: Oct. 24, 2016

(51) Int. Cl. A47L 23/02; B08B 3/04; A47L 23/20

(52) U.S. Cl. CPC A47L 23/02; A47L 23/205; B08B 3/04

(57) ABSTRACT

A shoe cleaning system that uses a control system to mix a disinfectant agent with water to form a disinfectant solution, and to spray the disinfectant solution over a rough surface of a basin to clear and disinfect a bottom surface of a shoe, when the shoe being rubbed upon the rough surface of the basin. Various embodiments of each component of the shoe cleaning system is provided herein.

### BACKGROUND OF THE INVENTION

1. Technical Field

The present invention relates to a shoe cleaning system that uses a control system to mix a disinfectant agent with water to form a disinfectant solution, and to spray the disinfectant solution over a rough surface of a basin to clear and disinfect a bottom surface of a shoe, when the shoe being rubbed upon the rough surface of the basin.

2. Description of the Related Art

The “background” description provided herein is for the purpose of generally presenting the context of the disclosure. Work of the presently named inventors, to the extent it is described in this background section, as well as aspects of the description which may not otherwise qualify as prior art at the time of filing, are neither expressly or impliedly admitted as prior art against the present invention.

During the course of daily lives, individuals acquire a great deal of dirt on the soles of their shoes. Surfaces such as roads and sidewalks have a high content of food waste, animal excrement, organic decompositions, dirt and debris. This dirt contains harmful bacteria that could pose serious health risks if brought into a household or dwelling. As people walk from one area to another, considerable amounts of dirt, harmful bacteria, and other substances are transferred from the first area to the second by the soles of their shoes. The substances can include staining agents such as mud, oil, grease, ink or the like which can cause stains on rugs, carpets, tiles, on upholstered furniture and other applicable surfaces in the home or other enclosed space. In another example, slippery substances picked up on the streets and brought into a home or other enclosed space floor can make slippery indoor surfaces. Therefore, it is desirable to prevent tracking dirt or contaminants from the first area to the second area. A typical example is in the home where vast quantities of dirt are tracked from the outdoors to the indoors, particularly onto a freshly scrubbed floor or onto carpeting. In industry, dirt and grime are continually tracked from the shop area to the office area. In hospitals, bacteria and contaminants are transferred from hallways and outside areas into sickrooms, laboratories, and operating rooms. If dirt is not removed prior to entry, it can be tracked into a building and deposited on clean floors. In addition, in heavily trodden places such as a busy office, it may require a significant amount of cleaning-up work to remove such dirt and debris. Furthermore, dirt left on floors results in an unclean appearance and promotes the proliferation of harmful bacteria. In homes, tracking dirt is simply unsightly and causes additional cleaning chores. In industry, in addition to the additional cleaning chores, shop dirt in the form of oil or other slippery substances can present a considerable safety hazard. In medical facilities, the spread of contaminants and bacteria is directly related to the spread of infection and disease and the recovery rate of the infirm.

In an effort to reduce the transferring of dirt, doormats are used. Doormats can reduce the risk of unclean floors and bacterial growth by providing a surface that may be rubbed upon to affect the removal of dirt. Entry mats are commonly placed outside the doorways of homes, office buildings and businesses to remove dirt and debris from the soles of shoes prior to an individual's entry into the building, however, these mats are typically simple, carpeted or moisture-absorbing surfaces that collect particulate dirt and debris. After continual use, these mats become imbedded with dirt, dust and debris that limit their usefulness when cleaning a user's feet or shoes. These mats would be advanced by the addition of a disinfecting, moistening and drying capability in addition to a simple surface that merely removes of visible dirt and debris particles from a user's feet or shoe soles. These mats would be improved if provided a means to advance a new, unused surface to affect dirt removal after each use.

As an alternative to doormats, some people require shoes to be removed before entering their homes or businesses. Moreover, it is a tradition of many cultures and communities to require shoe removal before entering a home or a place of worship, in order to maintain purity and cleanliness of such an intimate space. However, many cultures are neither used to nor prepared for such a habit. For instance, in these cultures people wishing to remove their shoes have to decide whether to leave their shoes outside, pile them in a corner inside the house, carry them inside and wash the soles in a sink, or throw the shoes in a washing machine every day. Clearly, none of these measures is very popular or convenient. As a consequence, in many cultures people continue to walk in their homes, businesses, or other enclosed spaces wearing stained or contaminated shoes, taking the aforementioned risks.

There has been several attempts to create a shoe cleaning system that efficiently remove dirt and debris, and more importantly, harmful bacteria. For example, U.S. Pat. No. 5,991,967 discloses a cleaning device for shoe soles. The device includes an oscillating brush rack assembly contained within a housing. The brush rack assembly includes a plurality of spaced-apart and generally parallel brush rods with bristles. The device also includes a vacuum and a reservoir for catching and removing dirt removed from the shoe soles. Additionally, U.S. Pat. No. 4,233,707 discloses an apparatus for cleaning footwear comprising a closed system utilizing brushes and with recirculating compressed air. The apparatus has a housing and a cover containing a grill mounted to the housing by springs. Beneath the grill are a pair of cylindrical brushes rotated by electric motors in a direction toward the center of the grill. A combined vacuum cleaner and air compressor beneath the grill provides both a source of compressed air to help clean the shoes and suction to collect the dirt and any other debris dislodged by the apparatus. The brushes clean the bottoms of the shoes and direct any dislodged dirt and other debris toward the center area of the grill. A pair of air tubes disposed along the edges of the grill direct the compressed air over the shoes and toward the center of the grill, along with any debris dislodged. Beneath the center of the grill is a removable collection tank having a slot facing the grill and having an open end connected by a filter to the intake of the air compressor. The air compressor draws air into the tank through the slot and draws any debris in the collection area into the tank. The debris is removed from the air by the filter and the filtered air is then recompressed and recirculated via the air tubes over the top of the shoes.

Moreover, U.S. Pat. No. 5,839,144 relates to an automatic boot cleaning apparatus having at least three brushes and a scraper. The brushes are positioned to scrub the sole and sides of a boot or shoe. The scraper is positioned behind the brushes and may be used to remove the excess mud or dirt from the boot or shoe. The brushes are rotated by an electric motor, preferably in one direction, but optionally with an oscillatory motion to increase the effectiveness of the cleaning operation. In an alternative embodiment, the shoe cleaner is connected to a source of fluid pressure and has a plurality of fluid outlet nozzles secured to the scraper. The nozzles are arranged to spray fluid directly onto the brushes and thus are capable of effecting a self-cleaning operation. In addition to the above mentioned prior arts, some others use dry or wet brushes to clean the shoe soles (e.g. Pat. Nos. 1,277,834, 2,718,020, 3,048,867, 3,737,942, 5,950,269).

While the foregoing prior art patents disclose some useful shoe cleaning devices, they mostly utilizes a single brush or a plurality of brushes, which makes the cleaning of the device costly and tedious. Furthermore, most of the above designs comprise a rotating component disposed in the device, which requires a regular maintenance, and thus causes the maintaining of the device costly. Further, the presence of the rotating component in these devices would make the device less desirable from safety standpoint.

In view of the forgoing, one objective of the present invention is a shoe cleaning system that uses a control system to mix a disinfectant agent with water to form a disinfectant solution and to spray the disinfectant solution over a rough surface of a basin to clear and disinfect a bottom surface of a shoe, when the shoe being rubbed upon the rough surface of the basin. The basin does not have a brushing structure, thereby providing a simple shoe cleaning device that does not require regular cleaning and/or maintenance.

### BRIEF SUMMARY OF THE INVENTION

According to a first aspect the present disclosure relates to a shoe cleaning system, including, i) a vessel having a first and a second liquid inlet and at least one liquid outlet, ii) a water tank located upstream of and fluidly connected to the first liquid inlet via a water line, iii) a liquid container located upstream of and fluidly connected to the second liquid inlet via a first disinfectant line, iv) a first and a second control valve attached to the first and the second liquid inlets, v) a basin with a third liquid inlet located downstream of and fluidly connected to said liquid outlet via a second disinfectant line, vi) a third control valve attached to the third liquid inlet, vii) a pump disposed in between the basin and the vessel on the second disinfectant line, wherein a disinfectant solution is configured to be prepared by mixing water and a disinfectant agent in the vessel, and the disinfectant solution is configured to be pumped into the basin, and wherein the basin has a rough surface, and the disinfectant solution flows over the rough surface to disinfect a bottom surface of a shoe, when the shoe being rubbed upon the rough surface of the basin.

In one embodiment, the first control valve regulates a mass flow rate of water, the second control valve regulates a mass flow rate of the disinfectant agent, and the third control valve regulates a mass flow rate of the disinfectant solution.

In one embodiment, the shoe cleaning system further includes a liquid level control system to adjust a liquid level of the disinfectant solution inside the vessel.

In one embodiment, the shoe cleaning system further includes a propellant located inside the vessel to stir the disinfectant solution.

In one embodiment, a mass flow rate ratio of the disinfectant agent to water is within the range of 1:1000 to 1:1.

In one embodiment, the shoe cleaning system further includes a wastewater tank located downstream of and fluidly connected to the basin via a wastewater line.

In one embodiment, wastewater in the wastewater tank is recycled to the water tank.

In one embodiment, wastewater is disinfected prior to be recycled to the water tank.

In one embodiment, the shoe cleaning system further includes a perforated tube located inside the basin and is attached to the third liquid inlet, wherein the perforated tube is configured to spray the disinfectant solution over the rough surface of the basin.

In one embodiment, the third control valve is electrically operated.

In one embodiment, the third control valve is manually operated.

In one embodiment, the first and the second control valves are electric operated.

In one embodiment, the shoe cleaning system further includes a fourth valve attached to said liquid outlet.

According to a second aspect the present disclosure relates to a shoe cleaning system, including, i) a liquid container having a liquid outlet and a valve attached to the liquid outlet, wherein the liquid container is located on and fluidly connected to a water line via the liquid outlet, ii) a basin fluidly connected to the water line via a liquid inlet, iii) a control valve attached to the liquid inlet, wherein a disinfectant solution is configured to be prepared by adding a disinfectant agent to water in the water line, and the disinfectant solution is configured to flow over a rough surface of the basin to disinfect a bottom surface of a shoe, when the shoe being rubbed upon the rough surface of the basin.

In one embodiment, the control valve is electrically operated.

In one embodiment, the control valve is manually operated.

In one embodiment, the shoe cleaning system further includes a perforated tube located inside the basin and is attached to the liquid inlet, wherein the perforated tube is configured to spray the disinfectant solution over the rough surface of the basin.

In one embodiment, the shoe cleaning system further includes a wastewater tank located downstream of and fluidly connected to the basin via a wastewater line.

In one embodiment, wastewater in the wastewater tank is recycled.

In one embodiment, wastewater is disinfected prior to be recycled.

The foregoing paragraphs have been provided by way of general introduction, and are not intended to limit the scope of the following claims. The described embodiments, together with further advantages, will be best understood by reference to the following detailed description taken in conjunction with the accompanying drawings.

### BRIEF DESCRIPTION OF THE DRAWINGS

A more complete appreciation of the disclosure and many of the attendant advantages thereof will be readily obtained as the same becomes better understood by reference to the following detailed description when considered in connection with the accompanying drawings, wherein:

FIG. 1A represents a shoe cleaning system.

FIG. 1B is an isometric view of a basin of the shoe cleaning system.

FIG. 1C is a magnified image of a corner of the basin.

FIG. 1D is a front view of the basin of the shoe cleaning system.

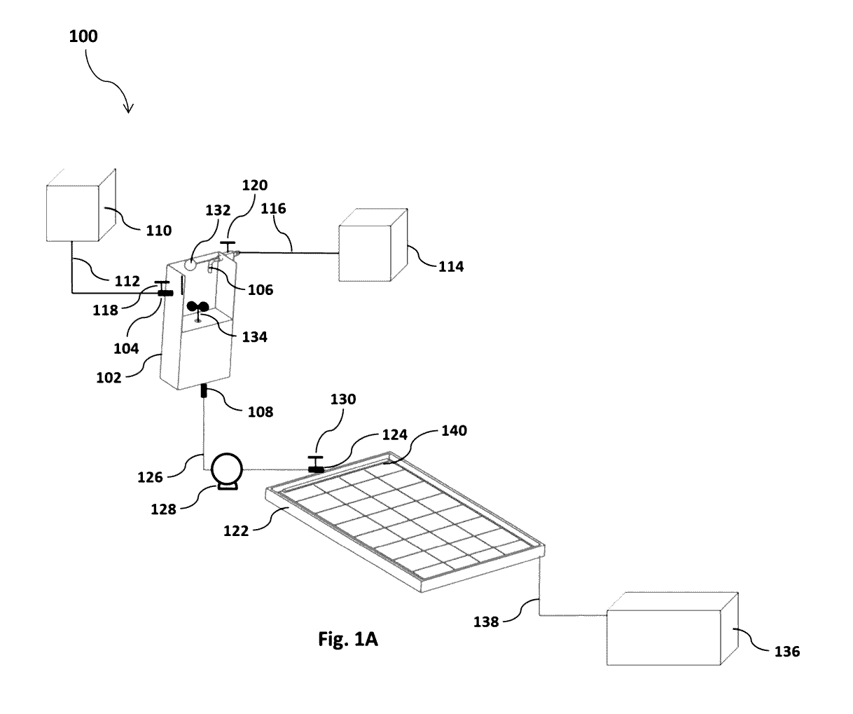

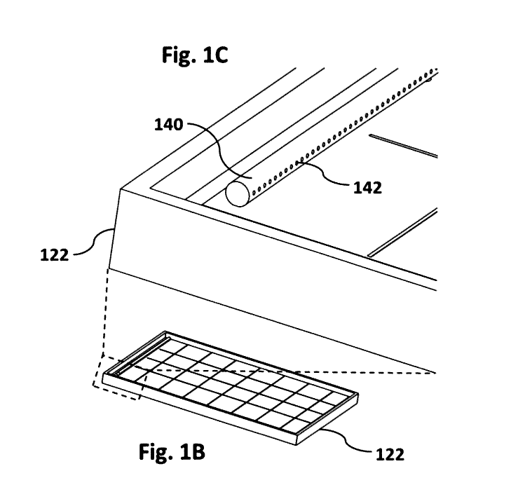

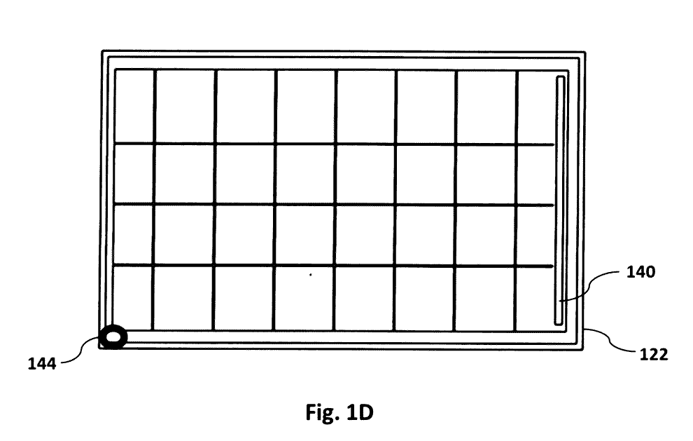

### DETAILED DESCRIPTION OF THE EMBODIMENTS

Referring now to the drawings, wherein like reference numerals designate identical or corresponding parts throughout the several views.

According to a first aspect the present disclosure relates to a shoe cleaning system 100, including a vessel 102 having a first 104 and a second 106 liquid inlet and at least one liquid outlet 108.

The shoe cleaning system 100 as used herein refers to an integrated system of individual components that prepares a disinfectant solution and distributes or sprays the disinfectant solution to a bottom surface of a shoe, which is exposed to the disinfectant solution, to clean dirt and debris, and to disinfect the bottom surface of the shoe from harmful bacteria.

The vessel 102 refers to a container that is designed to hold a liquid. In one embodiment, the vessel 102 is made of a metal or a metal alloy, although the materials used to construct the vessel are not meant to be limiting and various other materials may also be used. Exemplary metal alloys include, but are not limited to stainless steel, nickel steel, chromium steel, aluminum, aluminum alloy, copper and copper alloys, and titanium.

In a preferred embodiment, the vessel 102 has a rectangular geometry having an internal volume in the range of 100-50,000 mL, or preferably 500-10,000 mL, or preferably 1,000-10,000 mL. In one embodiment, the vessel 102 is substantially spherical having an internal volume in the range of 100-50,000 mL, or preferably 500-10,000 mL, or preferably 1,000-10,000 mL. In another embodiment, the vessel 102 is cylindrical having a length in a preferable range of 0.1-2 m, or preferably 0.5-1 m, and an internal diameter in the range of 0.1-0.5 m, or preferably 0.1-0.3 m, or preferably 0.1-0.2 m. The vessel 102 may also have a wall thickness in the range of 0.1-5 cm, or preferably 0.5-2 cm, or preferably about 1 cm. The vessel 102 may also have other geometries including, but not limited to oblong, cubic, conical, and pyramidal.

The shoe cleaning system 100 further includes the first 104 and the second 106 liquid inlets preferably located proximal to the top of the vessel 102, even though they can also be located proximal to the bottom of the vessel 102. In one embodiment, the first 104 and the second 106 liquid inlets are substantially similar, wherein each being a cylindrical tube having an internal diameter in the range of 1-20 mm, preferably 5-15 mm, more preferably about 10 mm, and is configured to be used to transfer a liquid from an exterior to an internal cavity of the vessel 102. In a preferred embodiment, each of the first 104 and the second 106 liquid inlets is made of a metal or a metal alloy and is welded to or is otherwise integral to the vessel. In another embodiment, both the first 104 and the second 106 liquid inlets are located on the same side and proximal to the top of the vessel. In a preferred embodiment, the first liquid inlet 104 is located on a first side and the second liquid inlet 106 is located on a second side, wherein the first and the second sides are the opposing sides of the vessel.

The shoe cleaning system 100 further includes at least one liquid outlet 108 located proximal to the bottom of the vessel 102, preferably at the bottom side of the vessel 102. Said liquid outlet 108 is substantially similar to each of the first 104 and the second 106 liquid inlets.

“Proximal to the bottom” refers to a region in the internal cavity that is located less than 50%, preferably less than 40%, more preferably less than 30% of the height of the vessel when measured from the bottom of the vessel, with 0% being the bottom and 100% being the height of the vessel. Accordingly, “proximal to the top” refers to a region in the internal cavity that is located at least 50%, preferably at least 60%, more preferably at least 70% from the bottom of the vessel with 0% being the bottom and 100% being the height of the vessel. The height of a horizontally oriented cylindrical vessel is its diameter, whereas the height of a rectangular vessel is a length of the side which is perpendicular to the horizon.

Other than said inlets/outlets designed to allow ingress and egress of a liquid, the vessel 102 may be perfectly sealed to prevent any leakage of the liquid.

In one embodiment, the shoe cleaning system 100 further includes a propellant 134 located inside the vessel 102 to stir the disinfectant solution to form a homogenous solution. In a preferred embodiment, the disinfectant solution is stirred for at least 1 minute, preferably at least 2 minutes, more preferably at least 5 minutes prior to egress from the vessel.

The shoe cleaning system 100 further includes a water tank 110 located upstream of and fluidly connected to the first liquid inlet 104 via a water line 112. The water tank 110 may be a liquid containing vessel having a volume of in the range of 1-100 L, preferably 10-100 L, more preferably 10-50 L, which is designed for the purpose of holding water prior to being mixed with a disinfectant agent. The water tank 110 may be have a cylindrical, a spherical, a rectangular, a cubic, an elliptical, a conical, or a pyramidal shape.

The shoe cleaning system 100 further includes a liquid container 114 located upstream of and fluidly connected to the second liquid inlet 106 via a first disinfectant line 116. The liquid container 114 may be a vessel having a volume of in the range of 1-100 L, preferably 5-50 L, more preferably 5-20 L, which is designed for the purpose of holding the disinfectant agent prior to being mixed with water. The liquid container 114 may be have a cylindrical, a spherical, a rectangular, a cubic, an elliptical, a conical, or a pyramidal shape.

The shoe cleaning system 100 further includes a first 118 and a second 120 control valve attached to the first 104 and the second 106 liquid inlets. In one embodiment, the first control valve 118 regulates a mass flow rate of water being delivered from the water tank 110, and the second control valve 120 regulates a mass flow rate of the disinfectant agent being delivered from the liquid container 114. In a preferred embodiment, the first 118 and the second 120 control valves are electric operated. Each of the first and the second control valves may be a globe valve, a gate valve, a check valve, a diaphragm valve, or a shut valve, although the valve type is not meant to be limiting and various other type of valves may also be used.

The disinfectant solution is prepared by mixing water and the disinfectant agent in the vessel 102. In one embodiment, the first 118 and the second 120 control valves provides a mass flow rate ratio of the disinfectant agent to water to be within the range of 1:1000 to 1:1,preferably 1:500 to 1:10, more preferably 1:500 to 1:100, depending on the type of the disinfectant agent being used.

In one embodiment, the shoe cleaning system 100 further includes a fourth valve attached to said liquid outlet. The fourth valve may be electrically operated or manually operated. In a preferred embodiment, the fourth valve is substantially similar to the first and the second control valves.

In one embodiment, the shoe cleaning system 100 further includes a liquid level control system to adjust a liquid level of the disinfectant solution inside the vessel 102. The liquid level control system may include a liquid level sensor 132, a controller, and an actuator. In one embodiment, the liquid level sensor 132, which may be a floating-type liquid level sensor, commands the controller to activate/deactivate the actuator. In a preferred embodiment, the mass flow rate of water and the mass flow rate of the disinfectant agent are controlled by the controller, which may be a programmable logic controller (i.e. a PLC). The mass flow rate of water may be within the range of 0.01-100 L/min, preferably 0.1-5 L/min, more preferably 0.5-5 L/min, whereas the mass flow rate of the disinfectant agent may be within the range of 0.01-10 L/min, preferably 0.05-0.5 L/min, more preferably 0.1-0.5 L/min. In some embodiments, the liquid level sensor 132 mechanically switches the actuator to an on position, wherein the actuator is each of the first and the second control valves.

The shoe cleaning system 100 further includes a basin 122 with a third liquid inlet 124 located downstream of and fluidly connected to said liquid outlet 108 via a second disinfectant line 126.

The basin 122 as used herein refers to a platform having a rough surface, wherein a user stands thereon and rubs his/her shoe against the rough surface of the basin 122. In some embodiments, the basin 122 is tilted and forms an angle with the horizon, wherein the angle is less than 10 degrees, preferably less than 5 degrees, more preferably less than 3 degrees. Further, a drain hole 144 may preferably be located at, or in the proximity of, the lowest point of the basin 122. The lowest point refers to a point that has the lowest height when the basin is tilted. The drain hole 144 may be to collect wastewater accumulates on the surface of the basin 122. In another embodiment, the basin 122 has a surface area within the range of 0.2-50 m², preferably 0.5-10 m², more preferably 1-5 m². The basin 122 may have an oval, a circular, a rectangular, a square, a triangular, or a hemispherical shape.

In some preferred embodiment, the basin 122 is made of stone, or it is made of a ceramic or a tile and ceramic particles having a diameter within the range of 1-5,000 μm, preferably 100-1,000 μm are disposed thereon. In another embodiment, the basin is made of a metal or a metal alloy which is coated with a polymer (e.g. epoxy), and ceramic particles having a diameter within the range of 1-5,000 μm, preferably 100-1,000 μm are dispersed on a surface of said coating polymer. In another embodiment, the basin is made of a ceramic, a tile, a metal, or a metal alloy, wherein a sand paper is secured on a surface of the basin with the sand paper having a grit size within the range of 50-400, preferably 100-250.

In some embodiments, the shoe cleaning system includes a plurality of basins, each being fluidly connected to a plurality of liquid outlets disposed on the vessel. Accordingly, said basins may preferably be substantially similar, or they may be different.

In one embodiment, the third liquid inlet 124 as used herein is substantially similar to the first and the second liquid inlets, as described previously.

The shoe cleaning system 100 further includes a third control valve 130 attached to the third liquid inlet 124. In one embodiment, the third control valve 130 regulates a mass flow rate of the disinfectant solution. The third control valve 130 may be manually operated, although it is preferably electrically operated. The mass flow rate of the disinfectant solution may be within the range of 1-100 L/min, preferably 10-50 L/min, more preferably 10-20 L/min. That being said, a user can manually determine the duration of the third control valve 130 to be open, for example by pressing and holding a button that activates the third control valve 130. The duration of opening the control valve may vary, however, for an effective disinfection the third control valve 130 may stay opened for at least 10 seconds, preferably at least 30 seconds, but no more than 1 minute.

The shoe cleaning system 100 further includes a pump 128 fluidly disposed in between the basin 122 and the vessel 102. The pump 128 is configured to pump the disinfectant solution from the vessel 102 to the basin 122 via the second disinfectant line 126. The pump 128 as used herein may be a centrifugal, a rotatory, or a positive displacement pump, although the pump type is not meant to be limiting and various other type of pumps may also be used. In one embodiment, both the third control valve 130 and the pump 128 are activated or deactivated via the same button. Accordingly, pressing and holding a button activates both the third control valve and the pump and creates a flow of the disinfectant solution, whereas releasing the button deactivates both the third control valve and the pump and stops the flow of the disinfectant solution.

In one embodiment, the shoe cleaning system 100 further includes a perforated tube 140 located inside the basin 122 and is attached to the third liquid inlet 124, wherein the perforated tube 140 is configured to spray the disinfectant solution over the rough surface of the basin 122. In a preferred embodiment, the basin 122 has a rectangular geometry and the perforated tube 140 has a longitudinal axis and is located proximal and on the basin 122 such that the longitudinal axis of the perforated tube 140 being parallel to a side of the basin 122. The perforated tube may have a rectangular tubing shape (i.e. having a rectangular cross section), or preferably a round tubing shape (i.e. having a round cross section), which is extended straight along the side of the basin 122. In a preferred embodiment, the end of the perforated tube that is not connected to the third liquid inlet 124 is sealed. In one embodiment, the perforated tube 140 has perforations 142 that are equally spaced apart around the circumference and along a length of the perforated tube. In another embodiment, the perforations are equally spaced apart along a straight line that is parallel to the longitudinal axis of the perforated tube. The direction of a liquid that is sprayed out from inside the perforated tube may preferably be perpendicular to the side of the basin 122. In one embodiment, the perforated tube has perforations with no specific pattern. The perforations are substantially similar, preferably circular, having a diameter in the range of 0.5-2 mm, preferably 0.5-1 mm. The perforated tube 140 may have a length within the range of 0.5-10 m, preferably 0.5-5 m, or preferably 0.5-2 m with respect to the length of the basin which is in the range of 0.5-10 m, preferably 0.5-5 m, or preferably 0.5-2 m. The inner diameter of the perforated tube 140 may be in the range of 0.1-5 cm, preferably 0.5-3 cm, or preferably 1-2 cm, and the thickness of the perforated tube 140 may be in the range of 1-20 mm, preferably 3-10 mm, more preferably 5-10 mm, although other dimensions are possible and the perforated tube may still function as intended.

The disinfectant solution is configured to be pumped into the basin 122, which sprays over the rough surface of the basin 122 via the perforated tube 140. The depth of the disinfectant solution on the basin is less than 2 cm, preferably less than 1 cm, more preferably less than 0.5 cm. The disinfectant solution is configured to disinfect a bottom surface of an object, when the object being rubbed upon the rough surface of the basin. The term “disinfect” refers to a condition where at least 50%, preferably at least 80%, more preferably at least 90%, even more preferably at least 99% of the total bacteria present on the subject to be killed or disabled. In a preferred embodiment, a shoe is rubbed upon the rough surface of the basin. In another preferred embodiment, a dry mat is disposed adjacent to the basin 122 to dry the bottom surface of the shoe, after the shoe being rubbed upon the rough surface of the basin. The dry mat may be heated up, for example via an electric current, to speed up drying the bottom surface of the shoe. In one embodiment, drying the bottom surface of the shoe takes less than 10 seconds, preferably less than 5 seconds.

The disinfectant agent may be isopropyl alcohol, chlorhexidinc gluconate (CHG), povidone-iodine, iodophor, or any combinations thereof, although the disinfectant agent type is not meant to be limiting and various other type of regulatory approved disinfectant agents may also be used. Depending on the type of the disinfectant agent, a concentration of the disinfectant agent in the disinfectant solution may be at least 50 wt %, preferably at least 70 wt %, more preferably at least 80 wt %. However, if a concentrated disinfectant agent is used, the concentration of the disinfectant agent in the disinfectant solution may be up to 5 wt %, preferably up to 2 wt %, more preferably up to 1 wt %, with weight percent being relative to the total weight of the disinfectant solution. In a preferred embodiment, the disinfectant agent instantaneously dissolves in water without a need for a mixing.

In one embodiment, the water line 112, the first disinfectant line 116, and the second disinfectant line 126 are tubular channels that are configured to transport a liquid throughout the shoe cleaning system 100. In one embodiment, the water line 112, the first disinfectant line 116, and the second disinfectant line 126 are substantially similar, each being made of a metal or an alloy that is coated with a polymer (e.g. epoxy) to prevent corrosion. In a preferred embodiment, the water line 112, the first disinfectant line 116, and the second disinfectant line 126 are flexible, each being made from a polymeric material selected from the group consisting of polyethylene, polypropylene, polystyrene, poly vinyl chloride, halogenated copolyolefins, non-halogenated homopolyolefins, and/or a combination thereof

In one embodiment, the shoe cleaning system 100 further includes a wastewater tank 136 located downstream of and fluidly connected to the basin 122 via a wastewater line 138 and the drain hole 144. In one embodiment, wastewater in the wastewater tank 136 is disinfected with chlorine and/or UV, and further recycled to the water tank 110. In another embodiment, the wastewater tank 136 is substantially similar to the water tank 110. The wastewater line 138 may also be substantially similar to the water line 112.

According to a second aspect the present disclosure relates to a shoe cleaning system, including a liquid container having a liquid outlet and a valve attached to the liquid outlet, wherein the liquid container is located on a water line and fluidly connected to the water line via the liquid outlet.

The shoe cleaning system according to the second aspect further includes a basin fluidly connected to the water line via a liquid inlet. In one embodiment, the shoe cleaning system further includes a perforated tube located inside the basin and is attached to the liquid inlet, wherein the perforated tube is configured to spray the disinfectant solution over the rough surface of the basin.

The shoe cleaning system according to the second aspect further includes a control valve attached to the liquid inlet, which may be electrically operated or manually operated.

A disinfectant solution is configured to be prepared by adding a disinfectant agent to water in the water line. The disinfectant solution is configured to flow over a rough surface of the basin to disinfect a bottom surface of a shoe, when the shoe being rubbed upon the rough surface of the basin.

Detailed description of the shoe cleaning system in accordance with the second aspect is similar to the shoe cleaning system of the first aspect, except the shoe cleaning system of the second aspect does not include a water tank, and therefore, the disinfectant agent is continuously added to water in the water line. In addition, the shoe cleaning system of the second aspect, unlike the one in the first aspect, does not include a pump, and thus it utilizes a pressure of water in the water line to spray the disinfectant solution on the rough surface of the basin.

What is claimed is:

1. A shoe cleaning system, comprising:
a vessel having a first and a second liquid inlet and at least one liquid outlet;
a water tank located upstream of and fluidly connected to the first liquid inlet via a water line;
a liquid container located upstream of and fluidly connected to the second liquid inlet via a first disinfectant line;
a first and a second control valve attached to the first and the second liquid inlets;
a basin with a third liquid inlet located downstream of and fluidly connected to said liquid outlet via a second disinfectant line;
a third control valve attached to the third liquid inlet; and
a pump disposed in between the basin and the vessel on the second disinfectant line,
wherein a disinfectant solution is configured to be prepared by mixing water and a disinfectant agent in the vessel, and the disinfectant solution is configured to be pumped into the basin, and
wherein the basin has a rough surface, and the disinfectant solution flows over the rough surface to disinfect a bottom surface of a shoe, when the shoe being rubbed upon the rough surface of the basin.

2. The shoe cleaning system of claim 1, wherein the first control valve regulates a mass flow rate of water, the second control valve regulates a mass flow rate of the disinfectant agent, and the third control valve regulates a mass flow rate of the disinfectant solution.

3. The shoe cleaning system of claim 1, further comprising:
a liquid level control system to adjust a liquid level of the disinfectant solution inside the vessel.

4. The shoe cleaning system of claim 1, further comprising:
a propellant located inside the vessel to stir the disinfectant solution.

5. The shoe cleaning system of claim 1, wherein a mass flow rate ratio of the disinfectant agent to water is within the range of 1:1000 to 1:1.

6. The shoe cleaning system of claim 1, further comprising:
a wastewater tank located downstream of and fluidly connected to the basin via a wastewater line.

7. The shoe cleaning system of claim 6, wherein wastewater in the wastewater tank is recycled to the water tank.

8. The shoe cleaning system of claim 7, wherein wastewater is disinfected prior to be recycled to the water tank.

9. The shoe cleaning system of claim 1, further comprising:
a perforated tube located inside the basin and is attached to the third liquid inlet, wherein the perforated tube is configured to spray the disinfectant solution over the rough surface of the basin.

10. The shoe cleaning system of claim 1, wherein the third control valve is electrically operated.

11. The shoe cleaning system of claim 1, wherein the third control valve is manually operated.

12. The shoe cleaning system of claim 1, wherein the first and the second control valves are electric operated.

13. The shoe cleaning system of claim 1, further comprising:
a fourth valve attached to said liquid outlet.

14. A shoe cleaning system, comprising:
a liquid container having a liquid outlet and a valve attached to the liquid outlet, wherein the liquid container is located on and fluidly connected to a water line via the liquid outlet;
a basin fluidly connected to the water line via a liquid inlet; and
a control valve attached to the liquid inlet,
wherein a disinfectant solution is configured to be prepared by adding a disinfectant agent to water in the water line, and the disinfectant solution is configured to flow over a rough surface of the basin to disinfect a bottom surface of a shoe, when the shoe being rubbed upon the rough surface of the basin.

15. The shoe cleaning system of claim 14, wherein the control valve is electrically operated.

16. The shoe cleaning system of claim 14, wherein the control valve is manually operated.

17. The shoe cleaning system of claim 14, further comprising:
a perforated tube located inside the basin and is attached to the liquid inlet, wherein the perforated tube is configured to spray the disinfectant solution over the rough surface of the basin.

18. The shoe cleaning system of claim 14, further comprising:
a wastewater tank located downstream of and fluidly connected to the basin via a wastewater line.

19. The shoe cleaning system of claim 18, wherein wastewater in the wastewater tank is recycled.

20. The shoe cleaning system of claim 19, wherein wastewater is disinfected prior to be recycled.
